(19) United States
(12) Patent Application Publication
(10) Pub. No.: US 2006/0116981 A1
(43) Pub. Date: Jun. 1, 2006

(54) Method and system for automated data collection and analysis of a computer system

(76) Inventors: Stefan Krimmel, Muhlhausen (DE); Lilia Kotchanovskaia, Mannheim (DE); Klaus Dickgiesser, Karlsruhe (DE); Frank Imbierwitz, Heidelberg (DE); Michael Vollmer, St. Leon-Rot (DE)

Correspondence Address: KENYON & KENYON LLP, 1500 K STREET N.W., SUITE 700, WASHINGTON, DC, 20005, US

(21) Appl. No.: 11/095,517

(22) Filed: Apr. 1, 2005

Related U.S. Application Data
(60) Provisional application No. 60/631,538, filed on Nov. 30, 2004.

(51) Int. Cl. G06F 17/30

(52) U.S. Cl. 707/2

(57) ABSTRACT

Embodiments of the present invention relate to a method and system for automatically collecting data relating to a computer system and automatically analyzing the collected data. The data collected may be historical data, collected over an extended period of time such as a day, week or month. The data may be collected locally, and then automatically sent via a network to a remote site, where the analysis of the data is automatically performed by a support provider. A report based on the analysis may be automatically generated and stored electronically at a site accessible, via the network, to an interested party, such as a system user and/or intermediate support provider. The report may include recommendations for modifications to hardware and/or software of the computer system, based on the analysis. The report may enable a system user to prevent rather than react to problems, and to maintain a more efficient computer system.

This application claims the benefit under 35 USC 119(e) of U.S. provisional application 60/631,538 filed Nov. 30, 2004 and fully incorporated herein by reference.

### BACKGROUND OF THE INVENTION

Collection of data for the analysis of a computer system is known. However, often the operation of collecting and analyzing such data is reactive rather than proactive. That is, it is often not until things have reached a point where performance is noticeably or even seriously impaired that the data collection and analysis is done. Then, typically, a user must become manually involved, for example by causing a diagnostic program to be executed or the like. Usually, such a diagnostic program will only take a “snapshot” of system status when the problem occurred, and does not collect historical data. Thus, past approaches tend not be able to detect problems in the making, and when a problem does occur, system users must react on an urgent basis to fix the problem.

In view of the foregoing, an approach is called for that makes it easier to detect and prevent developing problems in a computer system, and to tune the system on a regular basis for better overall performance.

### BRIEF DESCRIPTION OF THE DRAWINGS

FIG. 1 shows a high-level view of an arrangement according to embodiments of the present invention to transmit data relating to a computer system to a remote server computer corresponding to a support provider;

FIG. 2 shows one possible configuration of a computer system to be analyzed;

FIG. 3 shows further details of the computer system, including software components according to embodiments of the present invention;

FIG. 4 shows extracting the data relating to a computer system and transmitting it to the support provider, as may be performed in a process according to the present invention;

FIG. 5 shows analyzing of the data and generating a report based on the analysis, as may be performed in a process according to the present invention; and

FIG. 6 shows a process flow according to embodiments of the present invention.

### DETAILED DESCRIPTION

Embodiments of the present invention relate to a method and system for automatically collecting data relating to a computer system and automatically analyzing the collected data. The data collected may include information descriptive of a performance and/or state of the hardware and software included in the system. The data may be historical data, collected over an extended period of time such as a day, week or month.

Based on the analysis of the collected data, a report may be generated automatically. The report may include analytical information, that is, information generated as a result of processing the collected raw data according to some predetermined rules or logic. The report may further include recommendations for modifications to hardware and/or software of the computer system, based on the analysis.

The data relating to the computer system may be collected locally, and then automatically sent via a network to a remote site, where the analysis of the data is automatically performed by a support provider. The report resulting from the analysis may then be automatically stored electronically at a network site, e.g., an e-mail address, accessible to an interested party, such as a user of the computer system where the raw data was initially collected. By automatically collecting historical data as described, and automatically analyzing the data and reporting on the analysis, a user of the computer system may be provided with early warning of developing problems with the computer system, and of potential system enhancements. This enables the user to prevent rather than react to problems, and to maintain a more efficient computer system.

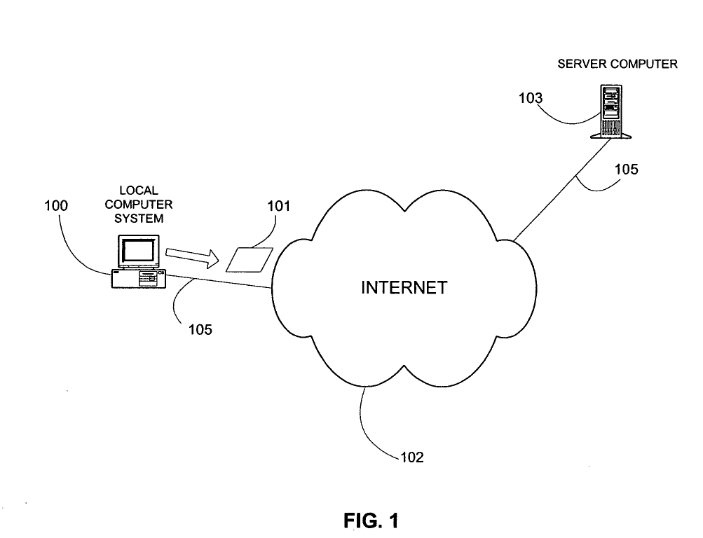

FIG. 1 shows a high-level view of an arrangement according to embodiments of the present invention. The arrangement includes a local computer system 100 coupled to a network 102, such as the Internet, via a communication link 105 (where a communication link 105 represents wired and/or wireless physical media coupling a node to the Internet 102). The computer system 100 may be configured with software according to embodiments of the present invention. By executing the software, data 101 relating to the computer system 100 may be automatically collected and sent via the Internet 102 to a server computer 103 also coupled to the Internet 102. The server computer 103 may correspond to a support provider that performs an automatic analysis of the data 101 and generates a report based on the analysis. A copy of the report may be stored electronically at a network site accessible to an interested party, such as a user of the local computer system 100, via the Internet 102. A copy of the report may be further be electronically stored at a network site accessible to an intermediate support provider, who may interface directly with the user to provide support services.

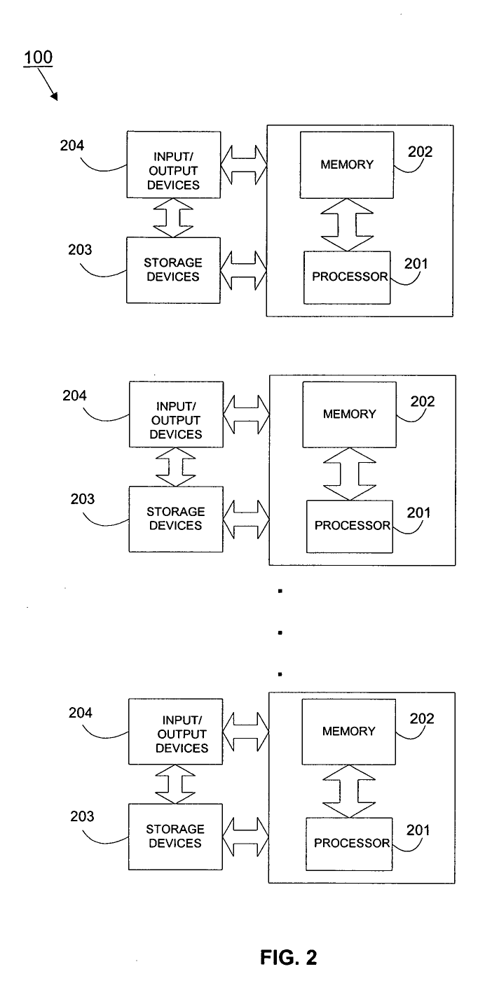

Referring to FIG. 2, the local computer system 100 may include one or more processors 201 each coupled to a memory 202, the memory 202 to hold instructions for execution by the processor, one or more bulk storage devices 203, such as “hard” or “fixed” disk, to electronically store data, and associated input/output devices 204 such as disk or tape drives, display monitors, keyboards, mouses and so on. One or more databases may be stored on the storage devices 203. The representation of FIG. 2 is intended as only one example of a computer system configuration; while FIG. 2 shows a plurality of processor/memory pairs each with associated I/O and electronic storage devices, many other configurations of a computer system are possible. For example, one more processors might share a memory, or processor/memory combinations might share I/O and storage devices.

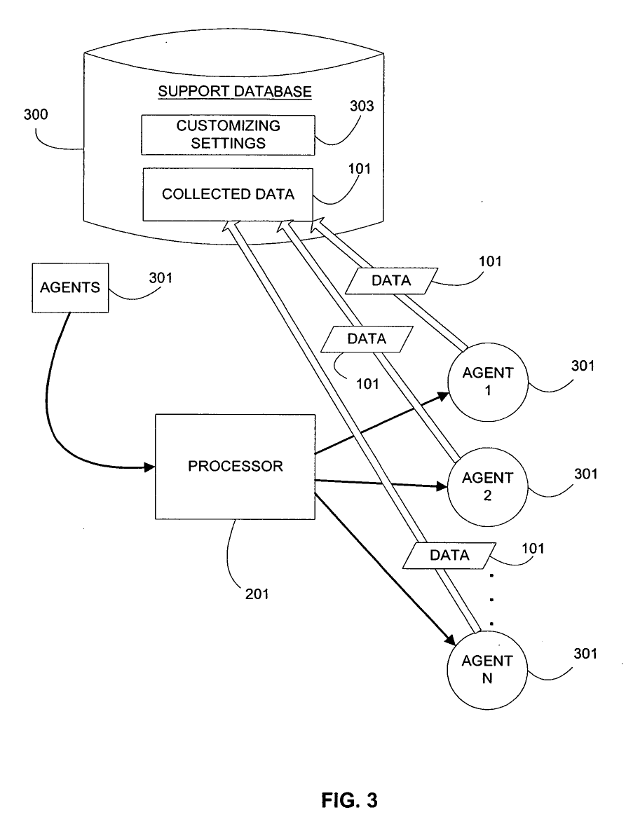

As noted, the computer system 100 may be configured with software according to embodiments of the present invention. Referring to FIG. 3, the software may comprise agents 301 stored on a machine-readable medium such as one of storage devices 203. The agents 301 may be started and execute on one or more of the processors 201. The agents 301 when started may collect data 101 about the hardware and software of the computer system 100, and store the collected data 101 in a support database 300. In embodiments, the agents 301 may be coded in the “C++” programming language, and the support database may be an SQL (Structured Query Language) database.

Respective agents may be designed to monitor different things about a computer system. For example, individual agents could be designed to respectively monitor processor (also, “central processing unit” or “CPU”) usage, memory usage, database usage, user information such as how many users are using the computer system, information about user-installed software such as which release or version of a particular software package is installed, application information such as what applications are currently executing or will execute, system configuration information, and so on.

Agents may be started manually, e.g., by user manipulation of a user interface, or may start automatically. The latter could be customizable per computer system 100. For example, customizing settings 303 could be defined in the support database 300 to control a behavior of the agents. The customizing settings 303 may include control values to, for example, determine a time when the agents are to automatically start, how long the agents are to execute, how often the agents are to record monitored values in the support database, and the like.

For example, the customizable control values might specify: “Each Friday morning at 8 AM, automatically start agents.” Agent 1 might, for example, be designed to determine which version of an operating system is currently installed in the computer system 100; agent 2 might be designed to monitor and record database usage in the computer system 100; and agent 3 might be designed to monitor and record CPU usage in the computer system 100. The customizing settings 303 could specify, for example, that agents 2 and 3 are to record database and CPU usage, respectively, once per hour. Agents 4-N might monitor and record various other values relating to the computer system 100 in accordance with the customizing settings.

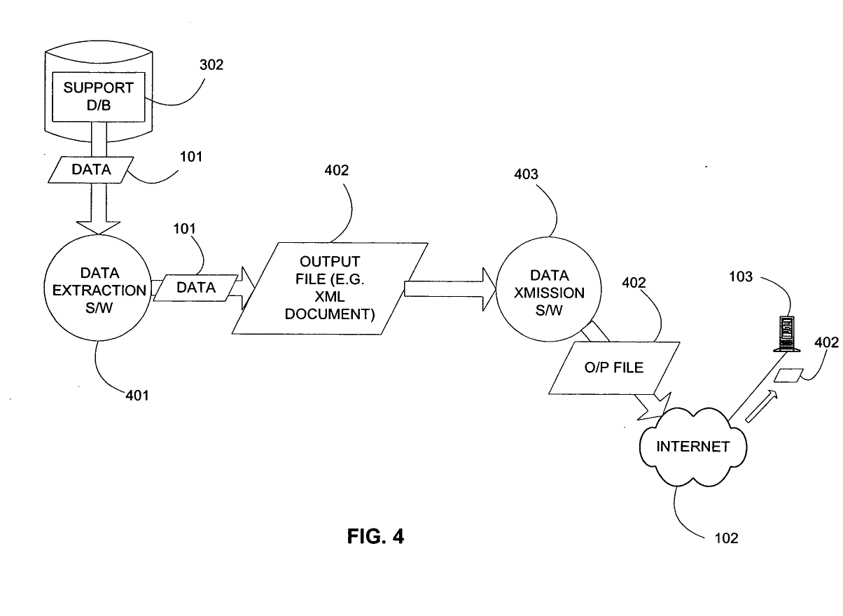

After the agents 301 have executed for a period of time, have collected data 101 relating to the computer system 100, and have stored the data 101 in the support database 300, further software according to embodiments of the present invention may be automatically executed. Referring to FIG. 4, the software may be data extraction software 401 that extracts at least a portion of the data 101 collected by the agents from the support database 300 and writes the at least a portion of the data 101 into an output file 402 for transmission to the server computer 103 via the Internet 102. In embodiments, the output file 402 may be an XML document. As is known, XML (Extensible Markup Language) is a meta-language created by the World Wide Web consortium, similar in certain respects to HTML (Hypertext Mark-up Language). Use of XML may facilitate conversion of the data 101 into a format suitable for being written into database tables and operated on by SAP ABAP software, as described in more detail below.

After the data 101 is written to an output file 402 for transmission over the Internet, data transmission software 403 according to embodiments of the present invention may be automatically executed to send the file 402. On the other hand, a user could choose a time to manually send the data.

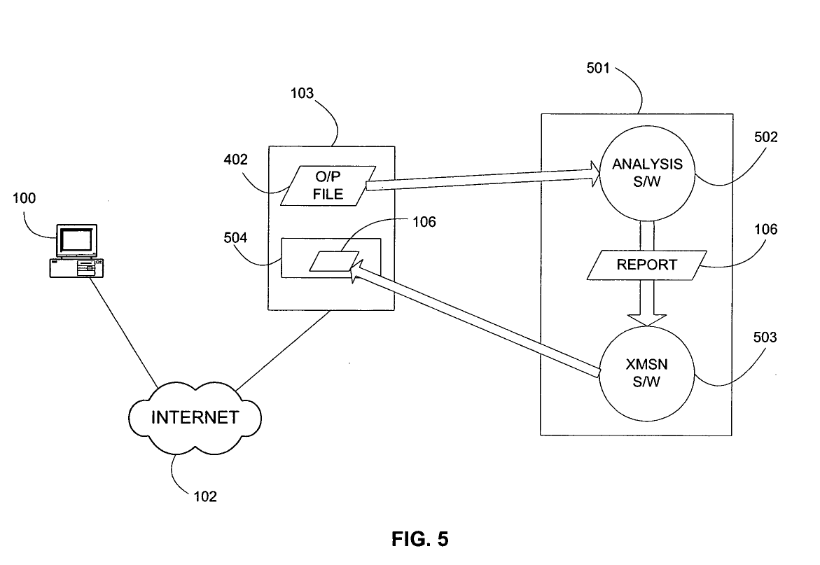

As noted earlier, the output file 402 containing data 101 may be sent over the Internet 102 to a remote computer server 103 corresponding to a support provider. In embodiments, the remote computer server 103 may be an SAP (more completely, SAP Aktiengesellschaft) “backend system” server. Referring to FIG. 5, the support provider may have a support facility 501 independent of the server 103, and retrieve the file 402 from the server 103 so that it may be analyzed in the support facility 501. For example, there could be a “firewall” interposed between the server 103 and the facility 501 of the support provider.

The support facility 501 of the support provider may include computer resources such as processors, memory, storage devices for storage of data electronically, and so on. Software may periodically execute on the support facility 501 to determine whether any new, as-yet-unprocessed files 402 have arrived on the server 103. If any new files 402 have arrived, the files 402 may be automatically retrieved from the server 103 so that the data 101 therein can be analyzed in the support facility 501.

The analysis may be automated. That is, there may be analysis software 502 resident in the support facility 501 that is automatically invoked when the file 402 (containing data 101) is brought into the support facility 501. The analysis software 502 may process the data 101 according to predetermined rules or logic to generate analytical information. For example, the analytical information could include computational results such as sums or totals. The analysis software might apply criteria to the data 101 to establish a performance measure of the corresponding computer system, such as a measure of CPU efficiency. The analysis software might compare values in the data 101 recorded over a period of time to detect trends. For example, by comparing a value representing database usage at the beginning of a month with a value representing database usage at the end of a month, the analysis software could compute a predicted growth rate in database usage.

The analysis software may generate a report 106 based on its analysis. The report 106 may include such information as all or some of the original values collected by the agents, and analytical values obtained by manipulating the values collected by the agents. For example, the analytical values could include, as noted earlier, performance measures, trends, rates, computational results such as sums or totals, and the like.

The report 106 may further include recommendations for modifications to hardware and/or software of the computer system, based on the analysis. For example, based on a performance measure, the report may identify one or more components of the corresponding system as under-performing, and recommend a hardware and/or software upgrade. As another example, based on a predicted growth rate in database usage, the report may alert a system user to the possibility that demand will soon exceed data storage capacity, and recommend, for example, starting an archiving project, or acquiring more data storage resources. Or, as still another example, based on identifying a release or version of installed software, the report might recommend a newer version of the software.

Once the report 106 is generated, transmission software 503 on the support provider end may be automatically executed to store a copy of the report 106 electronically at a site 504 accessible to an interested party, such as a system user and/or intermediate support provider, via the Internet 102. For example, the site 504 could correspond to an e-mail address and be accessible via e-mail protocols. The site 504 could be on server 103, but need not be. The system user and the intermediate support provider could have different e-mail addresses, and a copy of the report could be stored at each address. The e-mail addresses could be stored in the support database, extracted and sent with the output file 402 to the support provider, and extracted by the support provider to determine where to send copies of the report. In embodiments, the report 106 may be a Microsoft® Word file.

Further, in embodiments, the support facility 501 may include an R/3® system. “R/3®” refers to a known software architecture and its associated applications, developed by SAP Aktiengesellschaft. Accordingly, the analysis software may comprise programs coded in the ABAP language, and a process according to embodiments of the present invention may further include executing conversion software to convert the information in the XML document 402 into a format suitable for being written into R/3® database tables and operated on by ABAP software.

Further, according to embodiments, the local computer system 100 may be configured with SAP Business One software. SAP Business One is a known business software package designed by SAP Aktiengesellschaft for small-to-midsize companies that provides such capabilities such as accounting, reporting, financial management, inventory management and logistics, and sales force automation. Thus, at least a portion of the software according to embodiments of the present invention that is executed on the local computer system 100, including for example the agents and software for automatically sending the data 101 over the Internet to the server 103, may be implemented as an “add-on” to SAP Business One. Accordingly, this portion of the software may be called by one or more elements of the SAP Business One software and execute within an SAP Business One environment.

R/3® and SAP Business One may use a client/server processing model. Accordingly, components of the present invention could execute on a plurality of hardware platforms in a client-server environment. The environment may include client machines to handle front-end processing (e.g., user interfaces), application servers to process application logic, and database servers to handle database access.

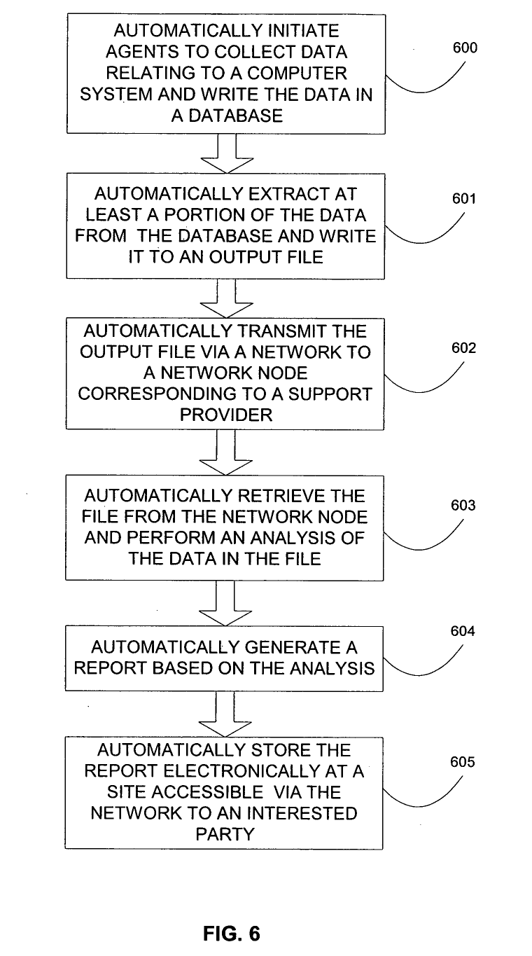

In view of the foregoing discussion, FIG. 6 shows a process flow according to embodiments of the present invention. As shown in block 600, the process may comprise automatically initiating agents to collect data relating to a computer system and write the data to a database.

As shown in block 601, the process may further comprise automatically extracting at least a portion of the data from the database and writing it to an output file. In embodiments, the output file may be an XML document.

The process may further include automatically transmitting the output file via a network, to a network node corresponding to a support provider, as shown in block 602. The network may be the Internet.

As shown in block 603, the process may further include automatically retrieving the output file from the network node and automatically performing an analysis of the data relating to a computer system contained in the file.

The process may further include automatically generating a report based on the analysis, as shown in block 604. The report may include at least one of all or a portion of the data originally collected, analytical information based on processing the originally collected data, and one or more recommendations for modifications to hardware and/or software of the computer system, based on the analysis.

As shown in block 605, the process may further include automatically storing a copy of the report electronically at a site accessible, via the network, to an interested party, such a system user and/or intermediate support provider.

As noted earlier, a computer program or collection of programs comprising computer-executable instructions according to embodiments of the present invention may be stored on a machine-readable medium such as disk (e.g., “hard” or “fixed” disk). Other machine-readable media that the instructions may be stored on include “floppy” disk, CD-ROM, and magnetic tape. The computer-executable instructions may be retrieved from the machine-readable media using a suitable reading device into a memory and executed by a processor. As is clear from the foregoing description, the computer-executable instructions may be distributed across a plurality of media, such as on physically separate storage devices respectively associated with physically separate computer systems that may communicate via a network. The functionality disclosed hereinabove may find specific implementations in a variety of forms, which are considered to be within the abilities of those of ordinary skill in the pertinent art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. An automated method comprising:
initiating, on a computer system, an agent to collect data relating to the computer system and to write the data to a database of the computer system;
extracting at least a portion of the data from the database and writing it to an output file; and
transmitting the output file via a network from the computer system to a support facility.

2. The automated method of claim 1, further comprising:
at the support facility, performing an analysis of the data relating to the computer system contained in the file;
generating a report based on the analysis; and
storing a copy of the report electronically at a site accessible via the network.

3. The automated method of claim 1, wherein the output file is an XML document.

4. The automated method of claim 1, wherein the network is the Internet.

5. The automated method of claim 1, wherein the report includes at least one of:
at least a portion of the data collected by the agent; analytical information based on processing the collected data; and a recommendation for modification of the computer system, based on the analysis.

6. The automated method of claim 1, wherein the agent automatically starts at a predetermined time, executes for a predetermined period, and records values in the database at predetermined intervals.

7. A computer system comprising:
a memory to store computer-executable instructions;
a processor coupled to the memory to execute the instructions;
computer-executable instructions to automatically:
collect data relating to the computer system and write the data to a database of the computer system;
extract at least a portion of the data from the database and write it to an output file; and
transmit the output file via a network from the computer system to a support facility, the support facility to perform an analysis of the data relating to the computer system contained in the file and generate a report based on the analysis.

8. The computer system of claim 7, wherein the output file is an XML document.

9. The computer system of claim 7, wherein the network is the Internet.

10. The computer system of claim 7, wherein the report includes at least one of: at least a portion of the data collected; analytical information based on processing the collected data; and a recommendation for modification of the computer system, based on the analysis.

11. The computer system of claim 7 where a copy of the report is stored electronically at a site accessible via the network.

12. A machine-readable medium storing computer-executable instructions to automatically:
collect data relating to a computer system and write the data to a database of the computer system;
extract at least a portion of the data from the database and write it to an output file;
transmit the output file via a network from the computer system to a support facility;
at the support facility, perform an analysis of the data relating to the computer system contained in the file;
generate a report based on the analysis; and
store a copy of the report electronically at a site accessible via the network.

13. The machine-readable medium of claim 12, wherein the output file is an XML document.

14. The machine-readable medium of claim 12, wherein the network is the Internet.

15. The machine-readable medium of claim 12, wherein the report includes at least one of:
at least a portion of the data collected; analytical information based on processing the collected data; and a recommendation for modification of the computer system, based on the analysis.

16. An automated method comprising:
starting, at predetermined time based on a customized setting, a plurality of software agents to collect data relating to a computer system, the data including information descriptive of a performance and/or state of the hardware and software included in the system;
collecting the data for a predetermined period of time at predetermined intervals, based on the customized setting, and storing the data in a database;
extracting at least a portion of the collected data from the database and writing the at least a portion of the extracted data into an output file; and
sending the output file to a server computer on a network.

17. The automated method of claim 16, further comprising:
converting the data in the output file into a format usable by analysis software;
executing the analysis software to perform an analysis of the computer system based on the converted data;
creating a report based on the analysis, the report including at least a portion of the data collected by the plurality of agents, analytical information based on processing the collected data, and a recommendation for modification of the computer system, based on the analysis; and
storing a copy of the report electronically at a site accessible via the network.

18. The automated method of claim 16, wherein the output file is an XML document.

19. The automated method of claim 17, wherein the database is an SQL database.

20. The automated method of claim 17, wherein the analysis software is coded in the ABAP language.
